(19) United States
(12) Patent Application Publication
(10) Pub. No.: US 2007/0211841 A1
(43) Pub. Date: Sep. 13, 2007

(54) Sonofusion Device and Method of Operating the Same

(76) Inventor: Nicholas A. Tomory, Stouffville (CA)

Correspondence Address: VIDAS, ARRETT & STEINKRAUS, P.A., SUITE 400, 6640 SHADY OAK ROAD, EDEN PRAIRIE, MN, 55344, US

(21) Appl. No.: 11/683,239

(22) Filed: Mar. 7, 2007

(30) Foreign Application Priority Data
Mar. 9, 2006 (CA) 2539054
Mar. 2, 2007 (CA) 2580290

(51) Int. Cl. H05H 1/22

(52) U.S. Cl. 376/100

(57) ABSTRACT

A sonofusion device is disclosed. The device has a reactor vessel for containing a cavitating liquid and for defining an axial wave path. A fusionable material located along said axial wave path, and a plurality of vibration elements are positioned along said axial wave path. Each of the vibration elements are sized and shaped to generate radial pressure waves converging on said axial wave path to create an antinode at least on said axial wave path. A controller is provided for said vibration elements to control the timing of when said radial pressure waves generated by said vibration elements converge on said axial wave path and to thereby create an axial pressure wave travelling along said axial wave path at a predetermined velocity. Also provided is a bubble initiator in said cavitating liquid at said antinode. A method of creating nuclear fusion is also disclosed and comprehended.

### FIELD OF THE INVENTION

This invention relates generally to the field of nuclear fusion devices, and more particularly to sonofusion devices of the type which utilize cavitation in a liquid to facilitate the release of energy.

### BACKGROUND OF THE INVENTION

Nuclear fusion is a prospective method of generating energy that promises to be clean, safe, and very productive. However, in spite of a great deal of research to date, an economically viable fusion-reactor has not yet been achieved. One of the key technical issues still to be effectively solved is how to produce the enormous pressures and temperatures needed to induce atomic nucleii to join or “fuse” together, and to confine the reaction after it occurs. Most of the research in this area has focussed on generating these extreme physical conditions by using extremely large and powerful lasers or magnetic fields.

Recently, research has progressed on an alternative method based on sound waves called “sonofusion” or “acoustic inertial confinement fusion (AICF)”. In this method, a vibrating element such as a ring-shaped piezo-electric crystal is used to generate a standing pressure wave inside a container filled with a deuterium-rich liquid. At the center of the wave the pressure varies between a peak positive pressure and a peak negative pressure. The sonofusion method further involves creating tiny bubbles of vapor by firing high energy neutrons (14.1 MeV) at the container at precisely the moment of peak negative pressure. By a process called cavitation, under the influence of the “stretching effect” of the negative pressure, the bubbles instantly balloon to about 100,000 times their original size (i.e. from a nanometer scale to about 1 mm size). Than, upon the pressure cycle turning positive and reaching its positive peak, the bubbles are crushed by the high pressure and implode. The implosion creates spherical shock waves which in turn create, in a very small region, temperatures and pressures on a scale potentially suitable for fusing nucleii. This has apparently been confirmed in the laboratory through observation of the expected products of nuclear fusion—low energy neutrons (2.45 MeV) and the hydrogen isotope tritium.

The sonofusion process summarized above is described and illustrated in greater detail in the article, “Bubble Power”, which was published in the May, 2005, issue of “IEEE Spectrum”. The article discusses two aspects of the current technology that need to be significantly improved before sonofusion can become economically viable. First, the energy output needs to increase from the current level of about 4×10⁵ neutrons/second to a level on the order of about 10²² neutrons/second. The other requirement is that the reaction needs to be made self-sustaining, so that the high energy neutron generator can be removed from the process. While the article proposes some measures to address these matters, it remains highly uncertain whether such steps will prove to be sufficient in practice.

U.S. patent application Ser. No. 09/981,512 which was published on Apr. 17, 2003, describes a nanoscale explosive-implosive burst generator using nuclear mechanical triggering of pre-tensioned liquids. According to the teachings of this patent application energy can be released upon the explosion or implosion of cavitation bubbles formed within a cavitating metastable liquid. Implosive collapse of the bubbles can be achieved through the application of a compressive pressure field to the cavitation bubbles. Implosive bubble collapse generates localized shock waves and can generate extremely high temperatures and pressures. The application suggests that implosive dynamics could be robust enough to lead to nuclear fusion, in particular, such that deuterium-deuterium or deuterium-tritium nuclear reactions can take place.

The application further teaches the use of an appropriate initiation source for applying cavitation energy to the fluid, including ionizing particles such as fundamental nuclear particles such as neutrons, alpha particles or fission fragments. Such sources are able to create nanoscale localized cavitation, but the teachings also cover using nucleating agents dispersed within the fluid to enhance the bubble nucleation rate.

The application further teaches that using an acoustic generator to generate a pressure wave timed to the creation of the cavitation bubbles can cause the implosion of the cavitation bubbles and so release energy. Although a number of reactor vessels are described the preferred one is spherical to permit an acoustical pressure wave to be concentrated at a central bubble nucleation site.

While interesting, the reactor design taught by this application has several drawbacks. For example, while the implosions create high local heat and pressure, they are occurring on a nanoscale and so the actual energy involved is very small. Further the energy released is somewhat isolated within the centre of the device and so may be difficult to recover. This prior art reactor design contemplates continuous creation and collapse of the bubbles at one specific site and thus is in the nature of a pulse type reaction rather than a continuous reaction. What is desired is an improved reactor design and sonofusion method that permits a more continuous reaction to develop.

### SUMMARY OF THE INVENTION

What is desired is a reactor vessel design that can overcome the limitations of the prior art designs discussed above. The present invention in a first aspect relates to a sonofusion device comprising:
a reactor vessel for containing a cavitating liquid and for defining an axial wave path;
a fusionable material located along said axial wave path;
a plurality of vibration elements positioned along said axial wave path each vibration element sized and shaped to generate pressure waves converging on said axial wave path to create an antinode at least on said axial wave path;
   a controller for each of said vibration elements to control the timing of when said pressure waves generated by said vibration elements converge on said axial wave path and to create an axial pressure wave travelling along said axial wave path at a predetermined velocity; and
a means for initiating bubbles in said cavitating liquid at said antinode on said axial wave path.

In an alternate aspect the present invention relates to a method of generating nuclear fusion, the method comprising:
providing a fusionable material in a liquid along an axial wave path;
creating a plurality of side-by side radial pressure waves crossing said axial wave path wherein said crossing radial pressure waves are sized and shaped to create a an antinode on said axial wave path;
delaying a phase of adjacent radial pressure waves to create an axial pressure wave moving along said axial wave path; and
   initiating alternating bubble formation and implosion along said axial wave path to promote fusion reactions in said fusionable material.

### BRIEF DESCRIPTION OF THE DRAWINGS

A brief description of the preferred embodiments of the invention will now be provided, by way of reference only, in reference to the following figures:

FIG. 1 is a configuration for a reactor vessel for defining a wave path according to one embodiment of the present invention;

FIG. 2 is a view of the reactor vessel of FIG. 1 showing standing radial pressure waves according to the present invention;

FIG. 3 is a schematic view of the reactor design of FIG. 1 showing an axial pressure wave arising from the plurality of radial pressure waves according to the present invention;

FIG. 4 side view of a section of the reactor of FIG. 1 having a pressure wave schematic superimposed thereon for illustration purposes;

FIG. 5 is a cross-sectional view through the reactor vessel of FIG. 1 illustrating a first order radial standing wave;

FIG. 6 is a cross-sectional view through the reactor vessels of FIG. 1 illustrating a second order radial standing wave;

FIG. 7 is a detailed schematic of a master command module for the present invention; and

FIG. 8 is a schematic for a vibration element or segment controller according to the present invention.

### DETAILED DESCRIPTION OF THE PREFERRED EMBODIMENTS

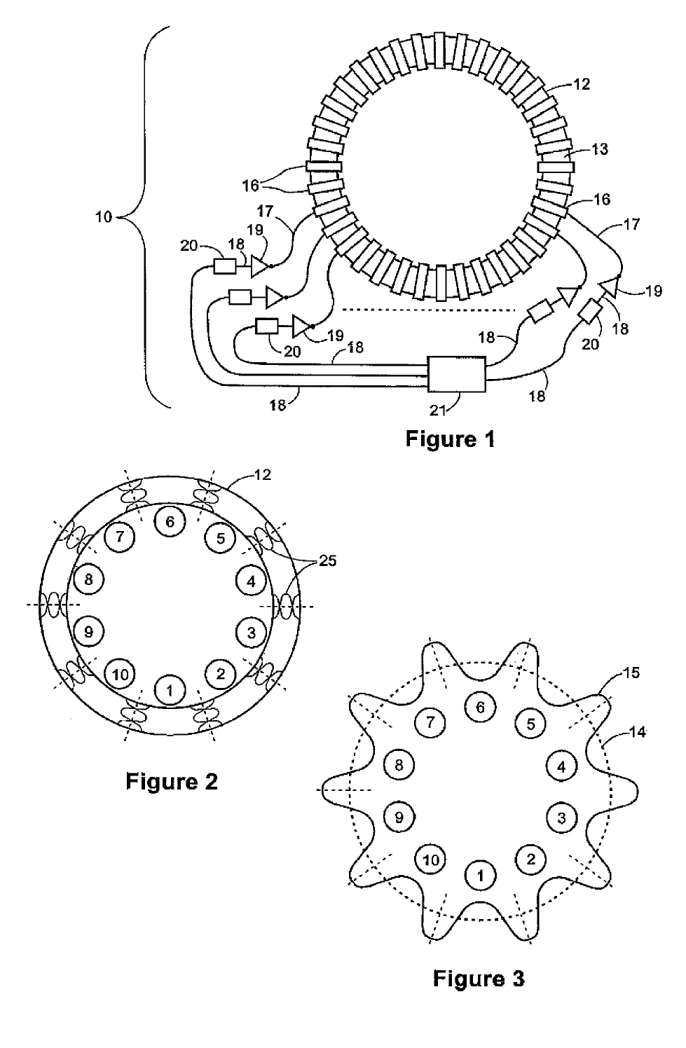

A sonofusion or acoustic inertial confinement fusion device is generally shown as 10 in FIG. 1. The device 10 includes a reactor vessel 12 defining an axial wave path 14. In a preferred from of the invention the reactor vessel 12 is in the shape of a torus and the axial wave path 14 is in the form of a circle, spiral, ellipse or other shape which provides an axial wave path 14 having some length. Closed loop paths are the most preferred Vibration elements or segments 16 are located around the perimeter of the axial wave path 14. Each vibration element 16 is connected by means of power connections 17 to a power amplifier 19, which is in turn connected to a vibration element or segment controller 20, which is finally connected to a master command module 21, by means of signal connections 18. While wire connections are preferred any signal connections 18 between the master command module 21 and the vibration element 16 that permits adequate triggered timing of the vibration elements 16 is comprehended by the present invention, including wireless connection.

Contained within the reactor vessel 12 is a cavitating liquid 13 having fusionable elements as will be known to those skilled in the art. Although many different cavitating liquids 13 could be used the preferred liquid 13 is believed to be deuterated acetone. The most preferred fusionable elements are believed to be deuterium-deuterium (D-D) or deuterium-tritium (D-T) nuclear reactions. Thus it is desirable to have such elements present in the cavitating liquid 13. Other types of fusion reactions are also comprehended by the present invention.

As described in more detail below, the vibration elements 16 are used to create radial pressure waves 25 (see FIGS. 3, 5 and 6) which are directed into the reaction vessel 12 across (i.e. substantially normal thereto) the axial wave path 14. As shown, one aspect of the invention is that instead of using a spherical or other shaped reactor vessel 12 having a single vibrational antinode, the reactor vessel 12 of the present invention defines an axial wave path 14 for a plurality of vibrational antinodes aligned along the axial wave path 14 as explained in more detail below.

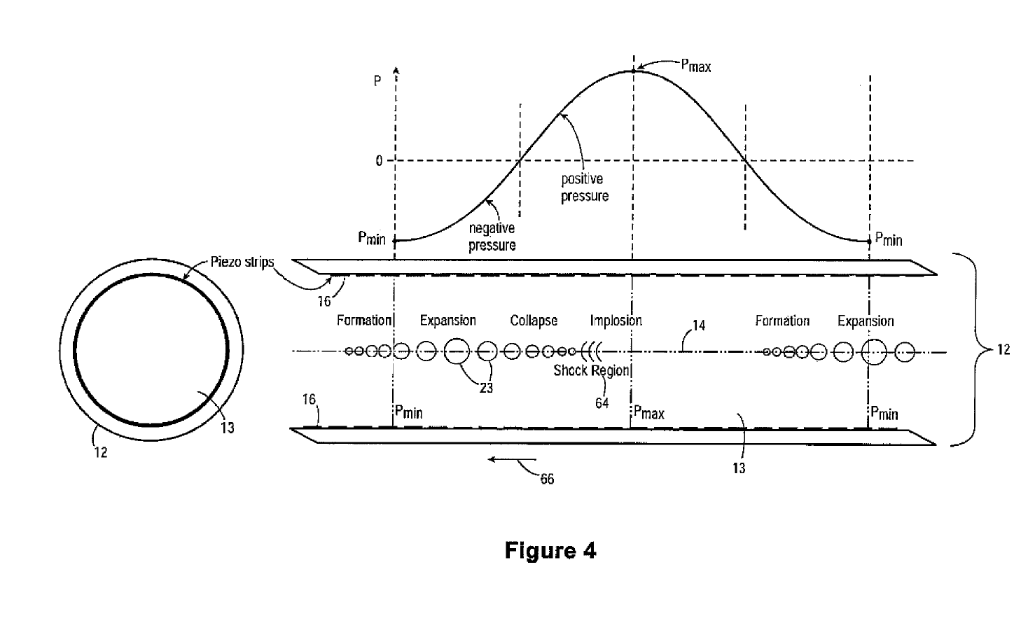

A property of the cavitating liquid 13 is the ability to form bubbles 23 (see FIG. 4), on a nanoscale, at the range of pressures capable of being generated by vibration elements 16. To initiate bubble creation the present invention contemplates the use of a means to initiate bubbles 23, such as a neutron gun, aimed through a low pressure region of the reactor vessel. The cavitating liquid 13 could include impurities to help seed the initiation of the cavitation bubbles. Additionally, the large number of fusion reactions occurring in the present invention create additional radiation which in turn can initiate bubble formation. Thus the present invention comprehends being able to turn the neutron gun off, after reactor start up, without loss of cavitation.

While the reactor vessel 12 shown in FIG. 1 is a simple torus, more serpentine paths such as a helix or coil-spring are also comprehended by the present invention. In some cases a more complicated shape is preferred because the energy output of the sonofusion device 10 is believed to increase with the length of the axial wave path 14 within the reactor. In cross section view, it is most preferred to form the reaction vessel 12 as a circle, to enable a peripherally generated radial pressure wave 25 to converge on the axial wave path 14 for maximizing the pressure cycle (i.e. maximum negative pressure to promote bubble formation and maximum positive pressure to maximize the implosive effect) at this antinode location. However, other cross sectional shapes may also be used provided the radial pressure waves 25 generated by the vibration elements 16 are focussed on the axial wave path 14 to cause a sufficient pressure cycle to create and implode the bubbles 23 in a manner to facilitate fusion reactions.

A preferred form of the vibration elements 16 is ring shaped piezoelectric crystals which can be electrically stimulated to vibrate in a precisely controlled manner. As can now be understood, the present invention uses a plurality of vibration elements 16 arranged adjacent to one another along the axial wave path 14. Each vibration element 16 will be capable of creating a radial pressure wave 25, which will be directed to the middle of reactor vessel 12 onto the axial wave path 14. Ideally, the vibration element 16 will encircle the axial wave path 14 and the radial pressure wave 25 initiated by the vibration element 16 at the periphery will converge at the axial wave path 14. According to the present invention, in this manner—an antinode site of the focussed radial pressure waves 25 emitted by the vibration element 16 lies on the axial wave path 14.

It is preferred, therefore, to have the vibration elements 16 ring-shaped and encircle the reactor vessel 12 and to produce focussed radial pressure waves 25 as described above. While the vibration elements 16 may be secured either on the outside or inside of the reactor vessel 12, being secured inside the reactor vessel 12 is preferred, as this will provide a more direct impact between the vibration element 16 and the cavitating liquid 13 within the reactor vessel 12. A thin internal passivation layer may be used to prevent chemical reactions between the fluid and the piezoelectric elements. As discussed above the present invention comprehends other cross-sectional shapes for the reactor vessel 12 and in such case, other shapes of vibration elements 16 may be preferred.

As indicated in FIG. 1, each vibration element 16 is independently driven by a dedicated amplifier 19 by means of a vibration element controller 20 which is described in more detail below. The amplifiers 19 operate at a common frequency, but are offset slightly in phase from their neighbours on either side in a predetermined manner, so that the vibration of one vibration element 16 is slightly offset from its immediate neighbour in time. By carefully controlling the timing of the vibrations of the vibration elements 16 the present invention comprehends creating an axial pressure wave 15 travelling along the axial wave path 14 as adjacent vibration elements 16 create radial pressure waves 25 slightly offset in time.

The pattern of pressure waves according to the present invention is shown schematically in FIGS. 2 (radial pressure wave) and 3 (axial pressure wave). As indicated in FIG. 2, each vibration element 16 produces a radially directed standing wave 25 in the region of the reactor vessel 12 which it encircles and so creates—an antinode pattern at the focus of the radial pressure wave 25. This focus or convergence point 24 is most preferably on the same axis for each adjacent vibration element 16 and so together the focus points of plurality of vibration elements 16 define the axial wave path 14. The multiple, adjacent vibration elements 16 of the present invention produce multiple adjacent radial pressure waves 25 along the axial wave path 14.

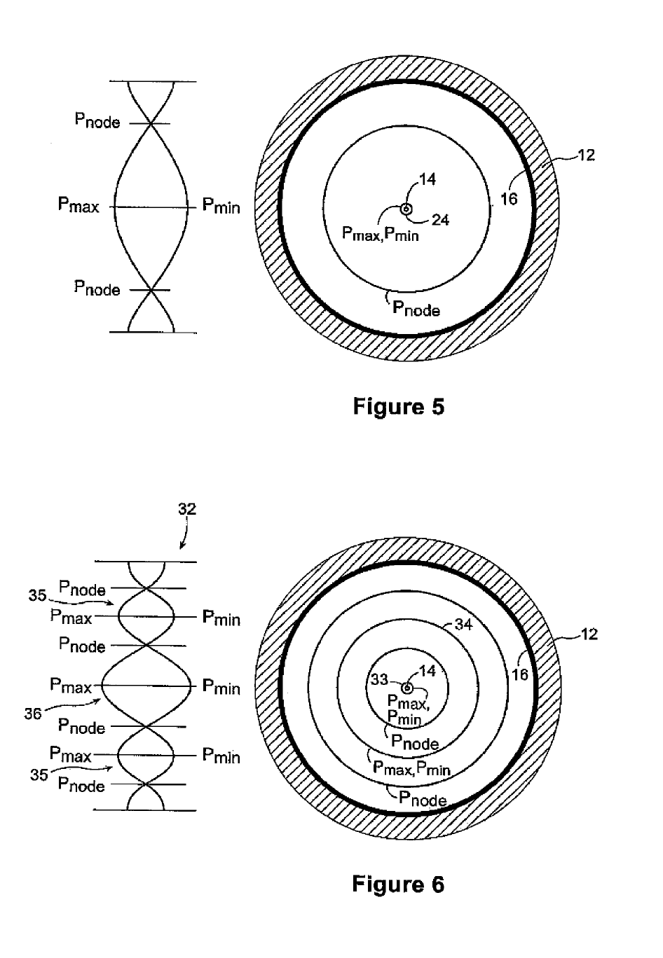

The production of the radial pressure wave 25 by the vibration elements 16 creates a wave that causes a pressure fluctuation at an antinode located at the convergence point or focus 24 of the cross-section area of the reactor vessel 12. In one operational mode, the wavelength of the radial pressure wave 25 equals the diameter of the reactor vessel 12 at that location. This operation mode is illustrated in FIG. 5. However, it can be appreciated that it may be advantageous to use a second order or higher wavelength, namely a harmonic of the first lower order standing radial pressure wave. Such higher order wavelengths have the potential of creating antinode locations at other places in the cross-sectional area of the reactor vessel 12 as shown in FIG. 6. FIG. 6 illustrates a second order standing radial pressure wave 32. The antinode site 33 at the centre, will be surrounded by a second ring shaped antinode site 34 at the radius of one half of the reactor vessel 12 radius and precisely 180 degrees out of phase with the main antinode site 33. The pressure amplitude 35 at this secondary ring site will likely be less than the pressure amplitude 36 at the centre. According to the present invention it is preferred if the pressure amplitude 35 at this secondary ring site 34 is sufficient to encourage fusion reactions, leading to more fusion reactions occurring in the reactor vessel 12 and a consequent increase in the release of energy. Advantageously, by being 180 degrees out of phase, each of the main central antinode and the secondary antinode will generate neutrons at precisely the right moment for the other to cause nucleation at the other site.

It is believed that the width of the main antinode pressure zone along the axial wave path 14 will generally correspond to the width of the vibration element 16. Thus, while fewer larger vibration elements 16 are preferred to reduce the overall expense of the sonofusion device 10, more and narrower vibration elements 16 will provide greater finite element control over the shape of the axial pressure wave 15 which is created along the axial wave path 14 due to the phase delay between adjacent vibration elements 16, and the consequent phase delay between adjacent standing radial waves. While more or fewer could be used, the preferred number is to use at least sixteen vibration elements 16 for each wavelength along the axial wave path 14.

FIG. 3 shows another view of the effect of the multiple adjacent standing radial pressure waves 25 along the axial wave path 14. When viewed from the center of the tube, there is produced a travelling phase or axial pressure wave 15 that moves along the axial wave path 14 within the reactor vessel 12, normal to the radial pressure waves 25. In the embodiment where the reactor vessel 12 is in the form of a continuous, closed loop, the axial pressure wave 15 is accordingly also continuous. Also as shown in FIG. 3, the continuous axial pressure wave 15 extends a multiple number of wavelengths in length. Specifically, FIG. 3 shows 10 wavelengths for illustration purposes. However, it will be understood by those skilled in the art that more or fewer wavelengths could be formed, depending upon the size of the reactor vessel 12 and the wavelength of the axial pressure wave 15 as compared to the overall length of the axial wave path 14.

The wavelength of the axial pressure wave 15 is determined by the phase-shifting in the timing of the amplifiers, and is set so that the wave 16 moves axially through the reactor vessel 12 at a predetermined phase velocity. FIG. 3 accordingly shows the axial pressure wave 15 at a particular instant in time T₁. At a slightly later time T₂, the overall shape of the axial pressure wave 15 will be the same, but will have shifted by a few degrees in the direction of the phase velocity. Therefore, at any given point in time the axial pressure wave 15 of FIG. 3 will have 10 points at peak or maximum pressure Pₘₐₓ, and 10 points at minimum pressure Pₘᵢₙ.

Another view of the process may be seen in FIG. 4, which shows one wavelength segment of the reactor vessel 12, along the axial wave path 14. In this figure the vibration elements 16, namely, the piezoelectric crystal strips, are located on the inside of the reactor vessel 12. Also shown, superimposed above the reactor vessel 12 tube segment, is a schematic showing the pressure distribution along the axial wave path 14 at that instant in time. As shown, according to the present invention, in and around the minimum pressure points Pₘᵢₙ, the overall pressure is negative leading to bubble formation and expansion. When the pressure turns positive the bubbles start to collapse, climaxing in an implosion near the point of maximum pressure Pₘₐₓ. At the nodes P_{node}, the pressure remains substantially constant and invariant (see FIGS. 5 and 6). Inside the reactor vessel 12 shock waves generated by bubble implosion are shown emanating outwardly from the implosion point. The present invention comprehends adjusting the phase velocity of the axial wave to match the velocity of the shock waves generated by bubble implosion to permit the shock wave energy and the pressure wave energy to be added together. In this manner as the axial pressure wave progresses along the axial wave path the implosion shock wave energy is gathered, amplifying the axial pressure wave and contributing to even greater implosion forces. In turn, greater implosion forces lead to more and more violent implosions which in turn further amplify the axial pressure wave to enhance the number of fusion reactions.

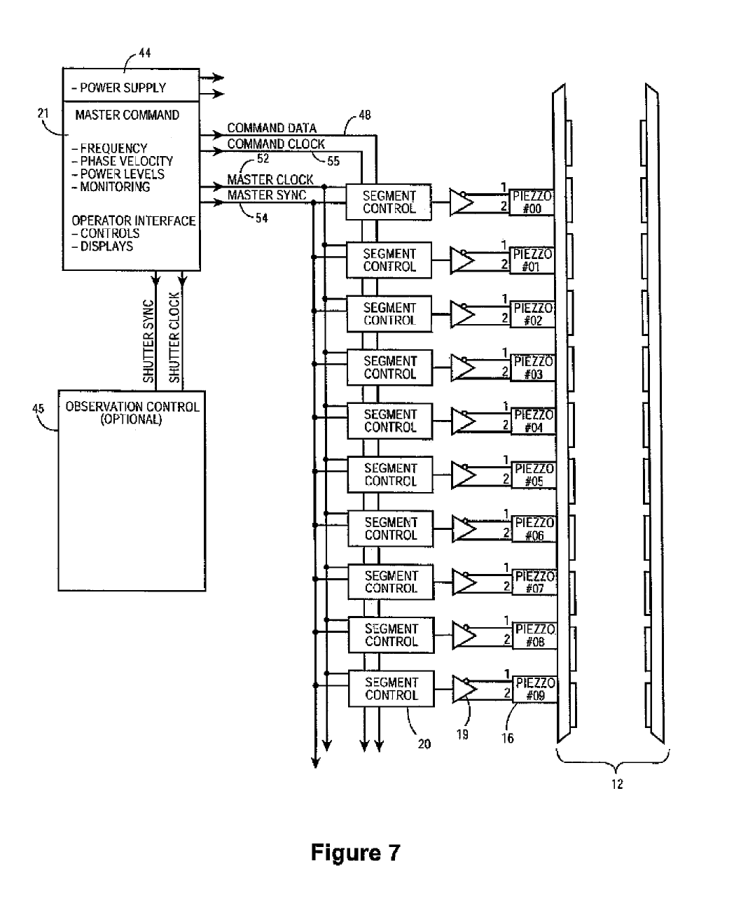

FIG. 7 is a schematic for an electronic controller 18 for the present invention. The master command or main control module 21 is capable of executing a number of functions. The master command module 21 may take the form of a digital computer, such as a PC. As shown a power supply 44 is provided to power the master command 21. The master command 21 is in charge of the frequency of the vibration elements 16, the timing of the vibration of the elements 16, which in turn determines the phase velocity of the axial pressure wave 15 down the axial wave path 14, the power levels and for monitoring the wave generation through continuous feedback. The master command 21 may also provide an associated operator interface, which can display the controls and other information relevant to the operation of the invention. As well, the present invention comprehends providing observational control 45 to an operator or observer as described in more detail below.

Beginning at the right hand side of FIG. 7, a section of the reactor vessel 12 is shown, in which a plurality of adjacent vibration elements 16 are positioned. Each vibration element 16 has a controller 46 connected by means of a power amplifier 19 to the vibration element 16 such as a piezoelectric crystal. All of the vibration element controllers 20 are in turn connected by a command data feed 48 and a command clock feed 50 to the master control 21. As well, each vibration element controller 20 is provided with a master clock input 52 and a master sync input 54, which are explained below.

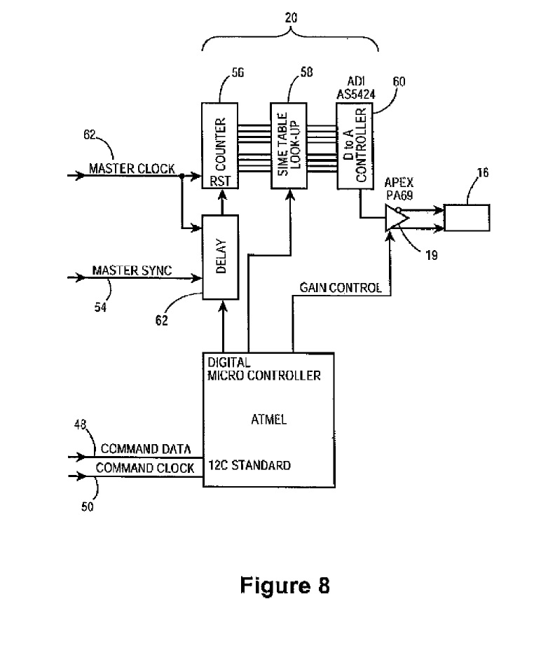

FIG. 8 shows a more detailed view of a preferred vibration element controller 20. As shown the master clock input 52 is directed to a counter 56, which then is connected to a sine lookup table 58, which in turn is connected to a Digital to Analogue converter 60. The master sync signal 54 is connected to a delay means 62 and then connected to the counter 56. A digital micro controller 64 (for example an AMTEGA 8518) with an I²C standard connection is used to receive the command data 48 and command clock 50 signals, to coordinate with the delay means 62, the sine look up table 58 and to provide gain control for the amplifier 19. The amplifier 19 in turn ensures the timed signal adequately powers the vibration element 16 to achieve the desired vibration.

Thus, each vibration element controller 20 consists of the components necessary to provide current and voltage levels to drive the associated piezzo electric ring vibration element 16. The two additional signals provided to each vibration element controller 20 are the master clock input 52 and the master sync input 54. The frequency of the master clock input 52 can be any convenient multiple of the radial pressure wave 25 frequency. In a preferred example this multiple is 256. In such case, the nominal clock frequency is about 256×20 Khz or about 5 Mhz. Of course, the actual frequency will be adjusted to create resonance (or a standing radial pressure wave 25) within the reactor vessel 12. Each vibration element controller 20 counts the master clock signal 52 in an 8 bit counter 56 producing a repeating count from 0 to 255. Thus, each count corresponds to an angle of 360/256=1.4 degrees. The output of the counter 56 drives the sine lookup table 58, which in turn drives the Digital to Analog converter 60. Then, the analogue signal is amplified at 19 to produce the power level required to drive the vibration element 16.

The synchronization and timing control of the individual vibration elements 16 can now be understood. At each vibration element controller 20 there is additional circuitry to generate a programmable phase delay between adjacent vibration elements 16. The phase delay determines the phase velocity of the axial pressure wave 15 along the axial wave path 14. In the foregoing example, a delay of one count generates a phase delay of 1.4 degrees. A delay of 256 counts provides a delay of 360 degrees. Thus, the present invention provides that a phase delay of any value between 0 and 360 degrees can be provided in 1.4 degree increments. The phase delay is under the control of the master command 21 through a digital command data feed 48.

As shown in FIG. 7 an observational device 45 is also contemplated by the present invention. While not required, it offers the possibility to observe more clearly what is happening in the reactor vessel 12 and is based on the sonoluminessence generated by bubble implosion which is visible light that can be observed. In this aspect, a pair of goggles (not shown), are provided for an observer, which are connected electronically to the master command 21. The goggles include optical shutters which can be synchronized with the main sonofusion device 10. Thus in a manner similar to a stroboscope, the shutters can be used to apparently slow down or freeze various aspects of the vibrations occurring in the reactor vessel 12 for direct observation. In this case it is preferred to make at least a portion of the reactor vessel 12 transparent to permit such observations to be made.

The advantages of the present invention can now be more fully understood. First, the potential output in neutrons/second is greatly enhanced over single node reactor vessel designs, due to the creation of multiple radial pressure waves 25, leading to multiple antinodes. Each radial pressure wave 25 is in effect an independent nuclear fusion site, creating and expanding bubbles 23 at the convergence point 24 of the pressure waves 25 when the pressure is near Pₘᵢₙ, and imploding the bubbles to encourage fusion reactions when the pressure nears the maximum pressure point Pₘₐₓ. It can also be appreciated that for a given frequency and amplifier timing setting, the total number of waves in the reactor vessel 12 and total energy produced increases with the length of the continuous reactor vessel 12. Accordingly, a factor in the power output of the present invention is the length of the reactor vessel 12.

Another aspect of the present invention is that, since the axial pressure wave 15 is continuous and merely shifts in space over time (at the speed of the phase velocity), the processes of bubble creation, implosion, and atomic fusion also become continuous. By contrast, in the prior art devices, these processes occur at a single node and only at the frequency of the signal driving the prior art vibration elements. The continuous nature of the present invention provides an opportunity of many more bubble implosions to be occurring in the reactor vessel 12 over a given time frame.

Another aspect of the present invention relates to the shock wave 64 produced at the Pₘₐₓ implosion point. As shown in FIG. 4, although the shock wave 64 emanates in all directions, part of the shock wave 64 moves in the same direction 66 as the phase velocity of the continuous axial pressure wave 15. The velocity of the shock wave 64 is somewhat faster than the speed of sound, and is about the same as the phase velocity of the radial pressure wave 25. According to the present invention, through adjustment of the driving amplifiers 19, the phase velocity of the axial pressure wave 15 can be made to match the velocity of the shock wave 64. Associated with each moving Pₘₐₓ site is a region of bubbles that have reached the implosion point. Such bubbles will be triggered into collapse by the shock wave 64. This has the potential of increasing not only the violence of the implosions, but their number as well, and will accordingly cause the reactors overall neutron production to be enhanced even further. The continuous nature of the axial pressure wave 15 of the present invention means that the shock wave 64, although on a nanoscale, can affect adjacent bubbles Through careful control of the phase velocity, the present invention comprehends using and amplifying this shock wave 64 as it progresses along the axial wave path 14 as previously explained.

The present invention further comprehends that the fusion reactions will be self-sustaining. As neutrons are created at the fusion sites, they are emitted in all directions, and travel at a speed that is essentially instantaneous with respect to the phase velocity of the axial pressure wave 15. Specifically, the neutron speed is about 2.16×10⁷ m/s, which is about 10% of the speed of light but 10,000 times the speed of sound in water. Therefore, at least some of the neutrons created at any given Pₘₐₓ implosion point will instantaneously appear at adjacent Pₘᵢₙ points. There they will be available to promote bubble nucleation, performing the same function otherwise performed by neutrons fired from an external high-energy neutron gun. Further, as the process reaches steady state, some of the neutrons generated will also have an impact at Pₘᵢₙ points beyond the two immediately adjacent out of phase antinodes. Thus, the present invention comprehends there being sufficient fusion reactions to enable self seeding bubble creation.

As noted previously, in the present invention the position of the piezzo electric transducers 16 is preferably located on the inside wall of the reactor vessel 12, in direct contact with the reactor fluid 13. As a result, the outer wall of the reactor vessel 12 can be reinforced, or made thicker and stronger, without compromising the ability of the transducers 16 to operate as described herein. The present invention therefore also comprehends that the cavitating liquid 13 in the reactor vessel 12 can be pressurized, within the stronger walled reactor vessel 12 which can be designed to contain the greater pressures. It is believed that by pressurizing the cavitating liquid 13 in the reactor vessel 12, bubble collapse will be enhanced since the ratio of Pₘₐₓ to Pₘᵢₙ will be increased. Also, operating at different pressures will allow different frequencies of pressure waves 25 to arise, permitting the optional tuning of the pressure wave characteristics of the reactor vessel 12 by means of pressure control.

It will be understood by those skilled in the art that various modifications and alterations can be made to the invention without departing from the broad scope of the invention as defined by the appended claims. Some of these modifications have been discussed above and others will be apparent to those skilled in the art.

The embodiments of the invention in which an exclusive property or privilege is claimed are defined as follows:

1. A sonofusion device comprising:
a reactor vessel for containing a cavitating liquid and for defining an axial wave path;
a fusionable material located along said axial wave path;
a plurality of vibration elements positioned along said axial wave path each vibration element sized and shaped to generate pressure waves converging on said axial wave path to create an antinode at least on said axial wave path;
a controller for each said vibration elements to control the timing of when said pressure waves generated by said vibration elements converge on said axial wave path and to create an axial pressure wave travelling along said axial wave path at a predetermined velocity; and
a means for initiating bubbles in said cavitating liquid at said antinode on said axial wave path.

2. A sonofusion device as claimed in claim 1 wherein said axial wave path is a linear wave path.

3. A sonofusion device as claimed in claim 1 wherein said axial wave path is in the form of a continuous loop.

4. A sonofusion device as claimed in claim 1 wherein said means for initiating bubbles along said path comprises a neutron source.

5. A sonofusion device as claimed in claim 4 wherein said neutron source is external to said axial wave path.

6. A sonofusion device as claimed in claim 4 wherein said cavitating liquid is a self nucleating fluid.

7. A sonofusion device as claimed in claim 1 wherein said plurality of vibration elements are arranged into segments along said axial wave path, and said device includes a controller for each segment.

8. A sonofusion device as claimed in claim 7 wherein each of said controllers consists of a binary counter, a digital sine look-up table, a digital to analog converter, and an amplifier sized and shaped to provide enough current and voltage to drive said vibration elements.

9. A sonofusion device as claimed in claim 8 wherein said vibration elements comprise piezzo electric vibrating bodies.

10. A sonofusion device as claimed in claim 9 wherein said piezzo electric bodies are in fluid contact with said liquid.

11. A sonofusion device as claimed in claim 10 further including a passivation layer between said piezzo electric bodies and said fluid.

12. A sonofusion device as claimed in claim 8 further including a master clock signal input and a master sync signal input for said controller wherein said master clock signal input permits said controller to activate said vibration elements sufficiently to create an axial pressure wave along said axial wave path.

13. A sonofusion device as claimed in claim 1 wherein said plurality of vibration elements are formed in a ring around said axial wave path.

14. A sonofusion device as claimed in claim 1 further including a master command module, said master command module including an operator interface, and wherein said master command module generates said master clock and master sync signal inputs for each of said controllers.

15. A sonofusion device as claimed in claim 1 further including a means for imposing a phase delay between adjacent vibration elements, wherein said phase delay determines a phase velocity of said axial pressure wave along said axial wave path.

16. A sonofusion device as claimed in claim 1 wherein said reactor vessel is circular in cross-section and has a diameter.

17. A sonofusion device as claimed in claim 16 wherein said vibration elements vibrate at a frequency sufficient to create a first order standing radial pressure wave across said diameter.

18. A sonofusion device as claimed in claim 16 wherein said vibration elements vibrate at a frequency sufficient to create a second order or higher standing radial pressure wave across said diameter

19. A method of generating nuclear fusion, the method comprising:
providing a fusionable material in a liquid along an axial wave path;
creating a plurality of radial pressure waves crossing said axial wave path wherein said crossing radial pressure waves are sized and shaped to create an antinode on said axial wave path
delaying a phase of adjacent radial pressure waves to create an axial pressure wave moving along said axial wave path; and
initiating alternating bubble formation and implosion along said axial wave path to promote fusion reactions in said fusionable material.

20. A method of generating nuclear fusion as claimed in claim 19 wherein said bubble implosions create a shock wave having a velocity through said liquid and said phase delay is selected to permit said axial pressure wave to have substantially the same velocity as said shock waves.

21. A method of generating nuclear fusion as claimed in claim 20 wherein said shock waves add to the energy of said axial pressure wave.

22. A method of generating nuclear fusion as claimed in claim 21 wherein said added energy creates more forceful bubble implosions.

23. A method of generating nuclear fusion as claimed in claim 22 wherein said more forceful implosions create large shock waves.

24. A method of generating nuclear fusion as claimed in claim 23 wherein said bubble shock wave pressures and said axial pressure waves are enough, in combination, to be self sustaining.
